(19) United States
(12) Patent Application Publication
(10) Pub. No.: US 2026/0029318 A1
(43) Pub. Date: Jan. 29, 2026

(54) PRESSURE-BASED METHOD TO DETERMINE INSTABILITY TEMPERATURE

(71) Applicant: Valero Services, Inc., San Antonio, TX (US)

(72) Inventors: Nelson J. Carvajal, Pearland, TX (US); Marisa Werner, Santa Fe, TX (US); Israel I. Sierra, Houston, TX (US); Don O’Donnell, The Woodlands, TX (US); Craig Hoaglin, Helotes, TX (US); Jill Burns, Boerne, TX (US)

(73) Assignee: Valero Services, Inc., San Antonio, TX (US)

(21) Appl. No.: 19/279,881

(22) Filed: Jul. 24, 2025

Related U.S. Application Data
(60) Provisional application No. 63/675,658, filed on Jul. 25, 2024.

(51) Int. Cl. G01N 7/16; G01N 25/48

(52) U.S. Cl. CPC G01N 7/16; G01N 25/48

(57) ABSTRACT

Provided are analytic methods for determining stability of a chemical sample, the methods comprising: heating the chemical sample within a calorimetric device, measuring a pressure within the calorimetric device while applying heat to the chemical sample, measuring a temperature of the chemical sample while applying heat to the chemical sample, identifying a pressure inflection point in the pressure data, identifying the temperature at the identified pressure inflection point, and determining stability of the chemical sample at the pressure inflection point by comparing the identified temperature and a predetermined threshold temperature.

### PRIORITY CLAIM

This application claims the benefit of and priority to U.S. Provisional Patent Application No. 63/675,658, filed on Jul. 25, 2024, the entire contents of which is hereby incorporated by reference.

### TECHNICAL FIELD

The present invention relates generally to the field of chemical thermal stability testing, particularly thermal stability testing of acids.

### BACKGROUND

When heated to a certain threshold, a chemical compound may undergo self-reaction or react with components of its environment. For instance, some compounds thermally decompose into their constituent parts upon reaching elevated temperatures. These decomposition products can subsequently react with one another or with the original chemical. This behavior is commonly observed in various acids stored in sealed containers. At higher temperatures, such acids may decompose to release gaseous byproducts and water. This is particularly true for oxygen-containing acids, where thermal decomposition can produce oxygen-containing compounds. The released compounds can then participate in further reactions, generating additional gaseous products and water. Moreover, the water produced can dilute the remaining acid, shifting the reaction kinetics to further favor oxidative processes.

In chemical reactions, a certain amount of energy-known as the activation energy-must be overcome to initiate the reaction. This threshold can be reached by increasing the system's temperature, which enhances molecular motion and collision frequency. As a result, some chemicals that are stable at ambient conditions may become reactive at elevated temperatures. Reaction rates are generally temperature-dependent, with higher temperatures accelerating the rate of reaction. In exothermic reactions, such as the oxidation of acids, the reaction itself releases heat, further raising the system's temperature. This can create a positive feedback loop: increased temperature accelerates the reaction, which generates more heat, leading to even higher temperatures. If unchecked, this cycle can culminate in a runaway reaction.

Devices exist that can test the thermal stability of chemicals, such as adiabatic calorimeters. For example, accelerating rate calorimeters (ARC) may be used for this purpose. These devices can measure thermal and pressure properties of exothermic chemical reactions within a sealed container over time. While effective, these tests may be costly and may take many hours to complete.

Chemical thermal stability may be a useful data point for optimizing operation of certain reactors, however it is cumbersome to utilize these data efficiently due to the long time periods associated with traditional thermal stability testing. Thus, there is a need for chemical thermal stability testing techniques that are accurate while reducing the required time.

### SUMMARY OF THE INVENTION

Provided herein are analytic methods for determining stability of a chemical sample, methods of operating alkylation reactors, and systems for carrying out the disclosed methods.

In an aspect, provided herein is an analytic method for determining stability of a chemical sample, the method including: heating the chemical sample within a calorimetric device, wherein the heating is controlled by a computer-implemented program applying heat to the calorimetric device according to a rate defined in at least a portion of a predetermined heating process; measuring, by a pressure transducer, a pressure associated with the calorimetric device while applying heat to the chemical sample according to the computer-implemented program; measuring, by a temperature sensor, a temperature of the chemical sample while applying heat to the chemical sample according to the computer-implemented program; determining a pressure inflection point in the pressure data recorded during the heating program, wherein after the pressure inflection point is a sustained pressure increase; determining the chemical sample temperature corresponding with the identified pressure inflection point; determining stability of the chemical sample at the pressure inflection point by comparing the identified temperature and a predetermined threshold temperature.

In some embodiments, the chemical sample is obtained from an acid solution comprising one or more acids diluted with one or more solvents, the acid solution having an acid strength of about 70 w/w % to about 100 w/w %.

In some embodiments, the predetermined heating process comprises a constant heating rate, a stepwise heating rate including a single step, a stepwise heating rate including multiple steps, a time-variable heating rate, a temperature-variable heating rate, a pressure-variable heating rate, or a combination of any two or more thereof.

In some embodiments, determining the pressure inflection point includes: trending output data from the pressure transducer to identify a time interval after a sustained pressure increase occurs, wherein the output data includes at least one of: a pressure value that is greater than a target pressure value; a slope of pressure value that is greater than a target slope value; a rate of change in the pressure value that is greater than a target rate of change value; an acceleration in the rate of change of the pressure value that is greater than a target acceleration value; and a monotonic increase in pressure; and identifying a local minimum pressure value contained within or before the associated time interval.

In some embodiments, the chemical sample is determined to be stable at the predetermined threshold temperature if the sample temperature at the pressure inflection point exceeds the predetermined threshold temperature or if there is no inflection point observed within the pressure data; and wherein the chemical sample is determined to be unstable at the predetermined threshold temperature if the predetermined threshold temperature exceeds the identified sample temperature at the pressure inflection point.

In some embodiments, the method includes adjusting a feed composition to an alkylation reactor based on the determined stability of the chemical sample. In some embodiments, the feed composition is adjusted to increase an amount of olefin in the feed composition when the chemical sample is determined to be stable at the predetermined threshold temperature; or wherein the feed composition is adjusted to decrease the amount of isobutane mixed into the feed composition when the chemical sample is determined to be stable at the predetermined threshold temperature. In some embodiments, the method includes adjusting energy applied to a mixing apparatus within an alkylation reactor based on the determined stability of the chemical sample. In some of these embodiments, the mixing intensity is increased when the chemical sample is determined to be unstable at the predetermined threshold temperature.

In another embodiment, presented herein is analytic method including: heating a chemical sample within a pressure chamber, wherein the heating is according to at least a portion of a predetermined heating process; measuring a pressure within the pressure vessel while heating the chemical sample to produce pressure data; measuring a temperature of the chemical sample while heating the chemical sample to produce sample temperature data; identifying in the pressure data a pressure inflection point associated with a sustained pressure increase; and processing the sample temperature data to determine a stability temperature of the chemical sample, wherein the stability temperature is the temperature of the chemical sample associated with a minimum pressure of the identified sustained pressure increase.

In some embodiments, the chemical sample is obtained from an acid solution comprising one or more acids diluted with one or more solvents, the acid solution having an acid strength of about 70 w/w % to about 100 w/w %.

In some embodiments, the predetermined heating process comprises a constant heating rate, a stepwise heating rate, a time-variable heating rate, a temperature-variable heating rate, a pressure-variable heating rate, or a combination of any two or more thereof.

In some embodiments, the method also includes adjusting a feed composition to an alkylation reactor based on the determined stability temperature of the chemical sample.

In some embodiments, the feed composition is adjusted to increase an amount of olefin in the feed composition when the stability temperature of the chemical sample is greater than a predetermined threshold temperature.

In another aspect, provided herein is a method of operating an alkylation reactor, the method including: obtaining an acid solution sample from an acid solution;

heating the acid solution sample within a calorimetric device, wherein the heating is controlled by a computer-implemented program applying heat to the calorimetric device according to a rate defined in at least a portion of a predetermined heating process; measuring a pressure within the calorimetric device while heating the acid solution sample; measuring a temperature of the acid solution sample while applying heat according to the computer-implemented program; identifying a pressure inflection point in the pressure data recorded during the heating program wherein after the pressure inflection point is a sustained pressure increase; identifying the temperature at the identified pressure inflection point; determining stability of the acid solution sample at a predetermined temperature according to the identified pressure inflection temperature and the predetermined threshold temperature; and adjusting a feed composition to the alkylation reactor according to the determined stability of the acid solution sample.

In some embodiments, adjusting the feed composition to the alkylation reactor includes increasing a concentration of olefin in the feed composition if the identified sample temperature at the pressure inflection point exceeds the predetermined threshold temperature; or wherein adjusting the feed composition to the alkylation reactor includes decreasing isobutane content of the feed if the identified sample temperature at the pressure inflection point exceeds the predetermined threshold temperature.

In some embodiments, the predetermined heating process includes a constant heating rate, a stepwise heating rate having a single step, a stepwise heating rate more than one step, a time-variable heating rate, a temperature-variable heating rate, a pressure-variable heating rate, or a combination of any two or more thereof.

In some embodiments, identifying a pressure inflection point associated with a sustained pressure increase in the pressure data includes: processing the pressure data to identify a portion of the pressure data associated with a time interval in which the pressure data includes at least one of: a pressure value that is greater than a target pressure value; a slope of pressure value that is greater than a target slope value; a rate of change in the pressure value that is greater than a target rate of change value; an acceleration in the rate of change of the pressure value that is greater than a target acceleration value; and a monotonic increase in pressure; and identifying a local minimum pressure value contained within or before the associated time interval.

In some embodiments, the method also includes obtaining a sample of an overhead gas produced during heating of the acid solution sample; and analyzing the overhead gas sample to determine a composition of the overhead gas sample, wherein the overhead gas sample composition is determined by one or more of gas chromatography-mass spectrometry (GC-MS), MS, vacuum ultraviolet spectroscopy (VUV), RAMAN spectroscopy, and Fourier transform infrared spectroscopy (FTIR). In some of these embodiments, determining the stability of the acid solution sample at the predetermined temperature may be performed according to the identified pressure inflection temperature, the overhead gas composition, and the predetermined threshold temperature.

Both the foregoing summary and the following brief description of the drawings and detailed description are exemplary and explanatory. They are intended to provide further details of the invention, but are not to be construed as limiting. Other objects, advantages, and novel features will be readily apparent to those skilled in the art from the following detailed description of the invention.

### BRIEF DESCRIPTION OF THE DRAWINGS

FIG. 1A is a flow chart depicting a method of analyzing a chemical sample by heating the sample and determining a pressure inflection point, according to an embodiment.

FIG. 1B is a flow chart depicting a method of analyzing a chemical sample, according to an embodiment.

FIG. 1C is a flow chart depicting a method of operating an alkylation reactor, according to an embodiment

FIG. 2 is a schematic of a calorimetric device in which the methods disclosed herein may be performed, according to various embodiments.

FIG. 3 is a schematic of a control circuit for performing at steps of the methods disclosed herein, according to various embodiments.

FIG. 4 shows an example of temperature and pressure measurements of a stable spent acid (acid strength 90.4 wt. %) using the methods described herein.

FIG. 5A shows an example of temperature and pressure measurements of an unstable spent acid (acid strength 86.9 wt. %) using the methods described herein, with an example of a pressure inflection point in the measured pressure data indicated.

FIG. 5B shows an additional example of temperature and pressure measurements of an unstable spent acid (acid strength 89.5 wt. %) using the methods described herein.

FIG. 5C shows an additional example of temperature and pressure measurements of an unstable spent acid (acid strength 90.2 wt. %) using the methods described herein.

FIG. 6 is a spectra of an overhead gas sample from an unstable spent acid, the spectra obtained using the methods described herein.

FIG. 7A is a representation of the spectra for oxygen in an overhead gas sample from an unstable spent acid, the spectra obtained using the methods described herein.

FIG. 7B is a representation of the spectra for sulfur dioxide in an overhead gas sample from an unstable spent acid, the spectra obtained using the methods described herein.

FIG. 7C is a representation of the spectra for isobutane in an overhead gas sample from an unstable spent acid, the spectra obtained using the methods described herein.

FIG. 7D is a representation of the spectra for isopentane in an overhead gas sample from an unstable spent acid, the spectra obtained using the methods described herein.

### DETAILED DESCRIPTION

### Overview

Alkylation process units, or alkylation reactors or alkylation units, are used in petroleum refineries to convert isobutane and low-molecular-weight alkenes (light olefins, e.g., a mixture of propene and butene) into alkylate, a high octane gasoline component. Alkylation process units use acids such as sulfuric acid or hydrofluoric acid as catalysts in reactions to convert isobutane and light olefins into a high octane gasoline component. When alkylating with sulfuric acid, over time the circulating catalytic acid accumulates acid-soluble byproducts of the reaction that reduce the overall acid strength, called acid soluble oil (ASO) or red oil. Thus, organic hydrocarbons and organic sulfates may be present in the acid phase. Other species, such as amines, may also be present in the acid phase due to their use in other parts of the oil refining process.

Spent acids may need to be transported to locations external to the alkylation process unit for regeneration or proper disposal. However, when at elevated temperatures, the spent acids may decompose into smaller constituent molecules, which may be volatile at those conditions. For example, at elevated temperatures sulfuric acid decomposes to form SO₂ and water. ASO species may undergo thermal degradation, resulting in heavier hydrocarbon species. Sulfuric acid may react with impurities in the acid solution, such as ASO and unreacted olefin, to form other gaseous species. When the amount of SO₂ exceeds the solubility limit of the bulk acid, it will evolve into a gaseous phase. Each of these pathways can contribute to the formation of a gaseous phase. The increased specific volume of the gaseous phase can increase pressure within a fixed container such as a storage tank or transport vessel. Further, SO₂ gas in an environment containing water can be corrosive and can cause undesired effects on those fixed containers that are constructed of materials not resistant to acidic corrosion.

Traditional methods of testing the thermal stability of spent acids require long periods of time ranging from hours to even days. As both the reactions of contaminants and the thermal degradation of acid both cause pressure increases, disentangling the source of the pressure increase can be difficult using traditional methods. The present methods may be used to more accurately determine the stability of the acid, allowing improved operation of alkylation reactors and other devices. These methods may be carried out using control systems as also presented herein.

### Methods of Determining Stability of Chemical Sample

The present disclosure provides methods of determining the thermal stability of a chemical sample that includes an acid, such as a chemical solution obtained from an alkylation process unit, using a calorimetric device. In any one of the embodiments described herein, the calorimetric device may be an accelerating rate calorimeter (ARC). The present methods determine the maximum temperature the chemical sample can reach before a sustained increase in pressure is detected. The maximum stability temperature is correlated to the stability temperature of the chemical sample. It would be expected that a chemical sample maintained at a temperature that is below its stability temperature would remain in a stable state.

In any embodiments of any of the methods disclosed herein, the chemical sample is obtained from an acid solution comprising one or more acids diluted with one or more solvents, the acid solution having an acid strength of about 70 w/w % to about 122.5 w/w %, or about 75 w/w % to about 95 w/w %, or about 80 w/w % to about 90 w/w %, or about 85 w/w % to about 87 w/w %, as determined by titration or by gravimetric analysis. In some embodiments, the acid solution has an acid strength of about 70 w/w %, 71 w/w %, 72 w/w %, 73 w/w %, 74 w/w %, 75 w/w %, 76 w/w %, 77 w/w %, 78 w/w %, 79 w/w %, 80 w/w %, 81 w/w %, 82 w/w %, 83 w/w %, 84 w/w %, 85 w/w %, 86 w/w %, 87 w/w %, 88 w/w %, 89 w/w %, 90 w/w %, 91 w/w %, 92 w/w %, 93 w/w %, 94 w/w %, 95 w/w %, 96 w/w %, 97 w/w %, 98 w/w %, 99 w/w %, 100 w/w %, 101 w/w %, 102 w/w %, 103 w/w %, 104 w/w %, 105 w/w %, 106 w/w %, 107 w/w %, 108 w/w %, 109 w/w %, 110 w/w %, 111 w/w %, 112 w/w %, 113 w/w %, 114 w/w %, 115 w/w %, 116 w/w %, 117 w/w %, 118 w/w %, 119 w/w %, 120 w/w %, 121 w/w %, 122 w/w %, and 122.5 w/w %. In some embodiments, the acid is sulfuric acid and the solvent includes water. In some embodiments, the acid is fluoric acid and solvent includes water. In some embodiments, the chemical sample was taken from the circulating acid of an alkylation process unit (i.e., an alkylation unit). In some embodiments, the sample is taken from the circulating acid of an operating alkylation process unit, such that stability of the circulating acid may be determined while the alkylation process unit is in operation.

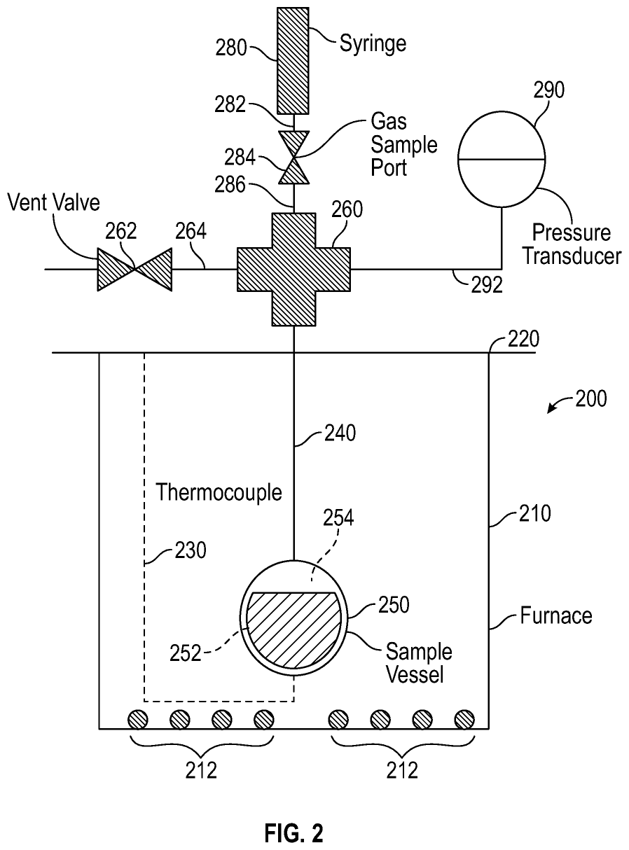

With reference to FIG. 2, the methods presented herein may be carried out, at least in part, in a calorimetric device 200. The calorimetric device may be any device known or unknown in the art, so long as it is able to heat the sample and measure the temperature and pressure of the sample during the testing. In the embodiment illustrated in FIG. 2, the calorimetric device 200 includes a sample vessel 250 contained within an insulated volume 210. The insulated volume 210 may have a removable lid 220 permitting access to the sample vessel 250 and providing a seal to the device when closed. As shown in FIG. 2, the insulated volume 210 may be a furnace having one or more heating elements 212. The heating elements 212 are configured to provide heat to the insulated vessel 210. The heating elements 212 may be electric, gas, or any other type of heating element, and may be at least partially embedded in the insulated volume 210.

A calorimetric device 200 may include a tap 240, which allows transmission of the gas within the sample vessel 250. A multi-way valve 260 can be used to control where the gas has access. In some configurations, the gas may be provided to a vent valve 262, which may include a bursting plate or which may be configured to be automatically actuated in the event that the pressure within the sample vessel 250 exceeds a predetermined threshold. Otherwise, the vent valve may permit for venting and depressurizing the sample vessel 250 after an experiment has been performed. The gas may also be collected at a gas sample port 282. Flow at the gas sample port 282 may be controlled by a sample port valve 284. The gas sample port 282 is configured to permit the gas to flow into a syringe 280 or other sampling device. The tap 240 may also provide a pressure line 292 to a pressure transducer, such that the pressure of the sample vessel 250 can be determined, measured, and/or monitored.

A method of determining the thermal stability of a chemical sample may include: 1) heating a chemical sample that includes an acid within a calorimetric device, and 2) monitoring the temperature and pressure within the calorimetric device that contains the chemical sample. The chemical sample may be of a particular mass or fluid volume. The temperature monitored may be the temperature of the chemical sample or another temperature associated with the calorimetric device (e.g., temperature of a vessel, probe, the chemical sample, or a gas phase in the calorimetric device). Advantageously, the method may be concluded when a sustained pressure increase is observed. Alternatively, the method may be continued for a predetermined amount of time or until the sample reaches a target temperature and/or pressure.

Another method of determining the thermal stability of a chemical sample may include: 1) heating a chemical sample that includes an acid within a calorimetric device, 2) monitoring the temperature and pressure within the calorimetric device that contains the chemical sample, 3) obtaining a sample of gas formed within the calorimetric device, and 4) analyzing the gas sample. The chemical sample may contain acid, and may be primarily acid. The temperature monitored may be the temperature of the chemical sample or another temperature associated with the calorimetric device (e.g., temperature of a vessel, probe, the chemical sample, or a gas phase in the calorimetric device). The gas sample may be analyzed using gas chromatography (GC), gas chromatography-mass spectrometry (GC-MS), MS, vacuum ultraviolet spectroscopy (VUV), RAMAN spectroscopy, Fourier transform infrared spectroscopy (FTIR), laser absorption spectroscopy, instrumental gas analysis (IGA), or any other method or technique known in the art. The heating of the chemical sample may conclude when a sustained pressure increase is observed, after a predetermined amount of time, or when the chemical sample reaches a target temperature and/or pressure. Similarly, the gas sample may be obtained when a sustained pressure increase is observed, after a predetermined amount of time, or when the chemical sample reaches a target temperature and/or pressure. Multiple gas samples may be obtained over the heating and/or after the heating of the chemical sample, or may be obtained continuously.

In another method, a gas sample from the heating of an acid sample is obtained and analyzed using one or more of the gas analysis methods listed previously. The gas sample is obtained when the acid sample is heated to a target temperature or when the acid sample reaches a target pressure. The composition of the gas sample is determined and the results are used to determine the stability of the acid sample at the target temperature or pressure. Thus, the stability of the acid sample is determined according to, at least in part, the composition of the gas given off by the acid sample.

In another method, multiple gas samples from the heating of an acid sample is obtained and analyzed using one or more of the gas analysis methods listed previously. The gas samples are obtained when the acid sample is heated to a target temperature or when the acid sample reaches a target pressure. The compositions of the gas samples are determined and that composition information is used to determine the stability of the acid sample across a range of temperatures or pressures. In this way, the stability of the acid sample is determined according to, at least in part, the composition of the gases given off by the acid sample over a range of temperatures.

In another method, a used acid sample is analyzed for stability using a calorimeter. In some embodiments, the used acid sample includes hydrocarbon material, such as acid soluble oils or red oil. The acid sample is heated and the pressure and temperature of the sample is monitored. A stability temperature is identified as the temperature at which a sustained pressure increase begins to be observed. The sustained pressure increase may be determined, for example, at or near a pressure inflection point. Gas released by the acid sample during heating may be collected during heating or afterward. The gas may be analyzed for composition, which can provide additional information regarding the reactions taking place in the acid during heating. The gas composition data may be used to further determine or adjust the determined acid stability temperature.

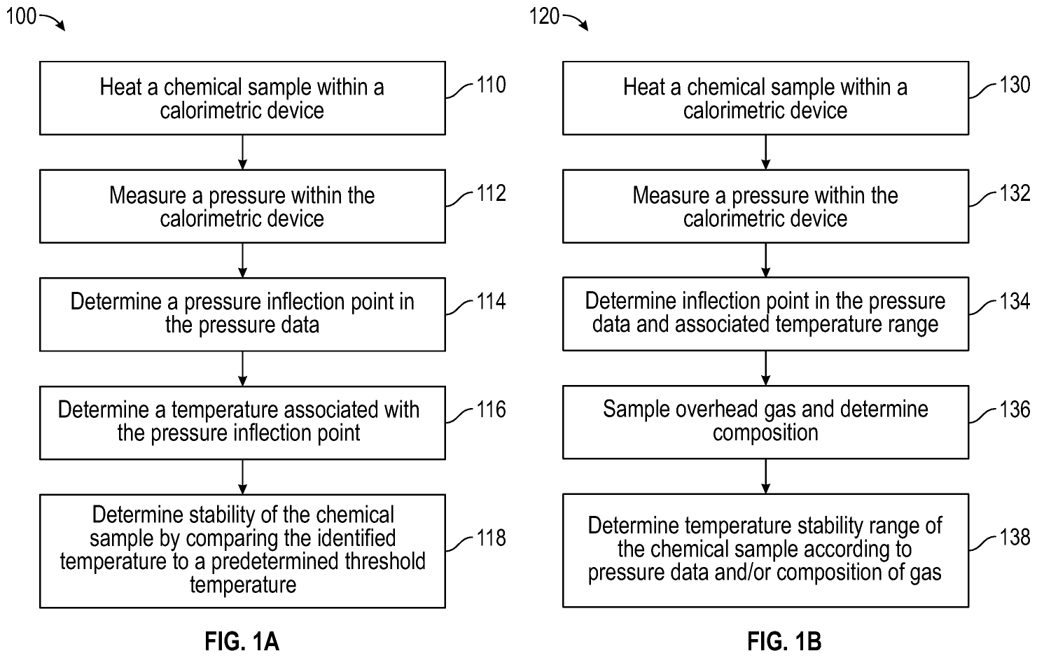

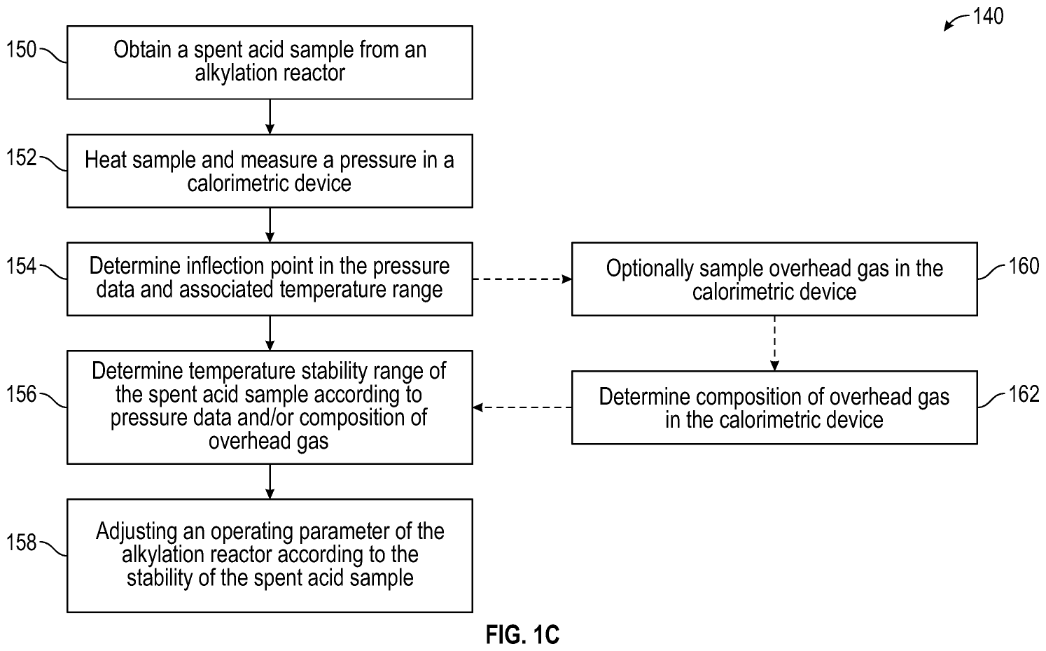

A method of analyzing the stability of a chemical sample is presented in FIG. 1A. As shown in FIG. 1A, the method may include: heating the chemical sample within a calorimetric device, wherein the heating is controlled by a computer-implemented program applying heat to the calorimetric device according to a rate defined in at least a portion of a predetermined heating process; measuring, by a pressure transducer, a pressure within the calorimetric device while applying heat to the chemical sample according to the computer-implemented program; measuring, by a temperature sensor, a temperature of the chemical sample while applying heat to the chemical sample according to the computer-implemented program; identifying a pressure inflection point in the pressure data recorded during the heating program, wherein after the pressure inflection point is a sustained pressure increase; identifying the temperature at the identified pressure inflection point; determining stability of the chemical sample at the pressure inflection point by comparing the identified temperature and a predetermined threshold temperature.

With reference to FIGS. 1A and 2, in a step 110 of a method 100, a chemical sample 252 including spent acid is placed in the sample vessel 250. The sample is heated in the sample vessel 250 by the heating elements 212. As the chemical sample 252 is heated, some of the sample is converted from the condensed liquid phase to the gas phase 254. Some of the sample 252 may convert to the gas phase through thermal degradation of material in the sample or due to reactions within the sample that give off gaseous products. For example, contaminants such as ASO, amines, and other chemicals, may react to produce gaseous products. Further, the acid in the sample may undergo thermal degradation, producing water, oxygen-containing compounds, and other gaseous species.

The heating step 110 may be performed according to a predetermined heating process. The heating step 110 may include a constant heating rate, a stepwise heating rate having a single step, a stepwise heating rate more than one step, a time-variable heating rate, a temperature-variable heating rate, a pressure-variable heating rate, or a combination of any two or more thereof. The heating rate may be controlled by a computer, as described in more detail below, or may be manually adjusted. The heating rate may range from 0.1-10° F./min, 0.5-5° F./min, 1.0-4° F./min, 0.1-2° F./min, 2.0-4.0° F./min, 0.1-5° F./min, or from 0.1-4° F./min. The heating rate may be applied to the sample to cause the sample to reach a selected temperature or undergo a selected rate of temperature increase. In some embodiments, the direct sample temperature is substituted with the temperature of another part of the calorimetric device 200, such as the temperature of the sample vessel 250.

A thermocouple 230 is used to monitor the temperature of the sample 252. The thermocouple 230 may directly or indirectly measure the sample temperature. Other temperature measuring devices may additionally or alternatively be used. Alternatively or additionally, the heating rate of the sample vessel 250 may be monitored, modeled, or otherwise determined to ensure that the heating rate adheres to the planning heating of the sample 252.

In another step 112, the pressure in the calorimetric device 200 is measured. As it is a closed system, the gas 254 produced by the sample causes the pressure within calorimetric device 200 to increase. A tap 240 in the sample vessel 250 provides a pressure line 292 for a pressure transducer 290. The pressure data from the pressure transducer 290 may be recorded with respect to time, heating rate, and/or a temperature. The pressure transducer may optionally be a pressure gage, or may include a pressure gage on the pressure line 292. A maximum temperature at which the chemical sample 252 is stable (i.e., is not thermally degrading or undergoing significant reaction) can be determined at least in part by analyzing the pressure data over time as the temperature increases.

In certain embodiments, additional considerations may be applied to enhance the accuracy and reliability of pressure measurements within the calorimetric device 200. The pressure transducer 290 and the pressure line 292 may be selected based on sensitivity, response time, and compatibility with the expected pressure range and chemical environment of the sample vessel 250. To minimize measurement artifacts, the pressure line 292 may be thermally insulated or maintained at a controlled temperature to reduce condensation or thermal expansion effects. Calibration of the pressure transducer 290 may be performed prior to each experiment using known reference pressures to ensure data integrity. Furthermore, the control system (described below) may include a data acquisition module configured to synchronize pressure readings with temperature and/or time data, allowing for high-resolution analysis of pressure changes during pressure-building events. In some configurations, redundant pressure sensors may be employed to provide validation or fail-safe monitoring.

In another step 114, a pressure inflection point in the data is identified. The term pressure inflection point is used for convenience—in some embodiments the inflection occurs over a range of values rather than a single point. The heating of the sample may continue until the end of the heating program, such as when a predetermined upper temperature limit for the sample has been reached. However, the testing of the sample may also be ended in response to a sustained pressure increase being observed or detected in the pressure measurements. The phrase “sustained pressure increase” is generally understood to refer to a pressure measurement data trend that is about monotonically positive. For example, it may refer to when there is a continuous increase in pressure over a selected period of time, a positive inflection point that is not observed to trend to a negative inflection point, or when there is a point in the measurement where there is a negative inflection followed by a sustained positive inflection. The positive inflection or positive monotonic data trend may level off, but shows few, if any, negative inflections/trends.

In some embodiments, identifying the pressure inflection point includes: trending output data from the pressure transducer to identify a time interval after a sustained pressure increase occurs, wherein the output data includes at least one of: a pressure value that is greater than a target pressure value; a slope of pressure value that is greater than a target slope value; a rate of change in the pressure value that is greater than a target rate of change value; an acceleration in the rate of change of the pressure value that is greater than a target acceleration value; and a monotonic increase in pressure; or identifying a local minimum pressure value contained within or before the associated time interval.

In some embodiments, the identification of a pressure inflection point may be performed using algorithmic or statistical analysis of the pressure data over time. A pressure inflection point may be defined as a point at which the second derivative of the pressure with respect to time changes sign, indicating a transition in the rate of pressure increase. This may correspond to the onset of a chemical reaction, decomposition, or other thermally induced transformation within the sample. Analytical techniques such as curve fitting, moving average smoothing, or derivative analysis may be employed to reduce noise and enhance the visibility of inflection behavior. In certain implementations, a threshold-based approach may be used, wherein a pressure rate-of-change exceeding a predefined value for a minimum duration is flagged as a potential inflection event. The identification of such a point may serve as a trigger for terminating the heating program or initiating additional safety protocols, particularly in reactive or hazardous sample testing scenarios.

In another step 116, a temperature associated with the pressure inflection point is determined. In some embodiments, determining the temperate associated with the pressure inflection point is done by identifying the temperature of the sample at which the sustained pressure increase was observed. In some embodiments, measuring the temperature of the sample is performed indirectly. The temperature measured may be a temperature associated with the sample vessel 250 such as a portion of the pressure chamber in which the gas phase 254 forms, in which case some correction may be necessary to ensure that the temperature is the temperature of the sample. The determination of the temperature associated with the pressure inflection point may account for additional considerations, such as fluctuations in the temperature at or near the pressure inflection point. The determination of the temperature associated with the pressure inflection point may be made according to a measured temperature and one or more correction factors. The correction factors may account for radiative effect, thermal resistances, contact resistance, insulation, thermal losses within the device, and other characteristics of the calorimetric device 200.

In another step 118, the stability of the chemical sample 252 is determined at a predetermined temperature. In some tests, it is expected that a sustained pressure increase will not be produced by the sample 252 during testing. In such a test, the sample would be understood to be stable across the tested temperature range. In other tests, the temperature associated with the pressure inflection point is compared to the predetermined temperature. If the temperature associated with the pressure inflection point is greater than the predetermined temperature, the chemical sample is determined to be stable at the predetermined temperature. However, if the temperature associated with the pressure inflection point is less than the predetermined temperature, the chemical sample may be unstable at the predetermined temperature, and some production of gas by the chemical sample should be expected.

Additional considerations in determining the stability of the chemical sample 252 at a predetermined temperature may include the rate and magnitude of pressure change at the pressure inflection point. For example, a minor or gradual pressure increase near the predetermined temperature may not necessarily indicate instability, especially if it falls within the expected noise threshold of the measurement system. Furthermore, the chemical composition, phase behavior, and potential for delayed decomposition reactions should be taken into account, as some materials may exhibit latent instability that is not immediately apparent during the initial testing period. In such cases, extended observation times or repeated thermal cycling may be employed to confirm stability. The presence of impurities such as ASO or amine, or environmental factors such as humidity and oxygen exposure, may also influence the onset of gas production, necessitating a more nuanced interpretation of the pressure-temperature relationship.

In some embodiments, the predetermined temperature is related to an expected temperature that a spent acid will be exposed to during transportation. For example, in some embodiments, the predetermined temperature may range from about 80° F. to about 150° F. (27° C.-66° C.), or from 90° F. to 130° F. (32° C.-54° C.), 100° F. to 120° F. (38° C.-49° C.), inclusive. In some embodiments, the predetermined temperature is about 80° F., 81° F., 82° F., 83° F., 84° F., 85° F., 86° F., 87° F., 88° F., 89° F., 90° F., 91° F., 92° F., 93° F., 94° F., 95° F., 96° F., 97° F., 98° F., 99° F., 100° F., 101° F., 102° F., 103° F., 104° F., 105° F., 106° F., 107° F., 108° F., 109° F., 110° F., 111° F., 112° F., 113° F., 114° F., 115° F., 116° F., 117° F., 118° F., 119° F., 120° F., 121° F., 122° F., 123° F., 124° F., 125° F., 126° F., 127° F., 128° F., 129° F., 130° F., 131° F., 132° F., 133° F., 134° F., 135° F., 136° F., 137° F., 138° F., 139° F., 140° F., 141° F., 142° F., 143° F., 144° F., 145° F., 146° F., 147° F., 148° F., 149° F., or 150° F., or is within a range between any two of these values.

In another aspect, provided herein is an analytic method comprising: heating a chemical sample within a pressure chamber, wherein the heating is according to at least a portion of a predetermined heating process; measuring a pressure within the pressure vessel while heating the chemical sample to produce pressure data; measuring a temperature of the chemical sample while heating the chemical sample to produce sample temperature data; identifying in the pressure data a pressure inflection point associated with a sustained pressure increase; and processing the sample temperature data to identify a stability temperature of the chemical sample, wherein the stability temperature is the temperature of the chemical sample associated with a minimum pressure of the identified sustained pressure increase.

With reference to FIG. 1B, another method of determining the thermal stability of a chemical sample 120 may include a step of heating the chemical sample 130 in a calorimetric device 200, as depicted in FIG. 2. Such heating is performed as described for the method 100 depicted in FIG. 1A and the description thereof applies to the present method as well. Similarly, the step of measuring the pressure 132 and the step of determining an inflection point in the pressure data 134 are performed as laid out in the steps 112 114 116 of the method 100 depicted in FIG. 1A, and so the description of these steps applies to the present method 120.

At a further step 136, a sample of the overhead gas 254 is taken from the sample vessel 250 via a sample port 282. The gas sample may be collected using a syringe 280, such as a floating glass syringe, or other known equipment. The timing of the gas sampling may be coordinated with specific thermal or pressure events, such as immediately following a pressure inflection point, after the pressure has stabilized, or at a predetermined temperature threshold. Additionally, the sample port may be equipped with a valve 284 or septum to maintain vessel pressure, prevent unwanted escape of pressurized gas, and minimize exposure of the sample to ambient air. The gas sampling equipment may be insulated to reduce temperature loss between collection and analysis.

The collected gas sample may be analyzed using one or more analytical techniques, such as gas chromatography (GC), mass spectrometry (MS), combined GC-MS, FTIR, VUV, RAMAN spectroscopy, FTIR, laser absorption spectroscopy, IGA or other known techniques. These methods enable both qualitative and quantitative assessment of the gaseous species present. GC, for example, allows for the separation of complex mixtures based on retention time, while MS, as another example, provides molecular weight and structural information for compound identification. The integration of GC-MS facilitates high-resolution analysis of decomposition products, reaction intermediates, and trace volatiles. Other testing methods may also be used to provide similar or additional data useful for optimizing the operation of the reactor. Calibration with known standards may be used to quantify the concentration of each species, and internal standards may be introduced to improve accuracy and reproducibility. The selection of species of interest for analysis may depend on the chemical nature of the sample and the expected decomposition pathways, and may include (though are not limited to) gases such as CO₂, CO, SO₂, or various organic volatiles. For spent acid samples, which contain contaminants such as ASO and, optionally, may contain amine, the species of interest may also include lighter hydrocarbons, sulfur-hydrocarbon complexes, amino-hydrocarbon complexes, oxygenated acid matrix molecules, and species that have reacted with the acid matrix. For example, when spent sulfuric acid is tested, the species may include sulfur dioxide (SO₂), organic sulfur species, amino-methyl, ethyl, or propyl species, water, and light hydrocarbons such as C1-C5 hydrocarbons in any of their various forms (n-, iso-, cyclic-). Other species, such as olefins, cycloolefins, and diolefins may also be present, depending on the initial composition of the sample.

Understanding the composition of the overhead gas sample provides useful insight into the underlying mechanisms of thermal or chemical instability of the sample, which can inform the determination of the overall stability of the chemical sample over a range of temperatures or at a particular predetermined temperature. The relative abundance of specific gaseous species can help distinguish between the volatilization of light components and breakdown of contaminants or the formation of light components as a result of reactions within the sample. For example, gas samples exhibiting lower concentrations of sulfur dioxide (SO₂) and higher concentrations of hydrocarbons and/or sulfur-hydrocarbon complexes may suggest that the observed gas evolution is primarily due to the volatilization of lighter hydrocarbons, or the reaction of organic contaminants (such as ASO) or residual process materials (such as heavier hydrocarbons or cyclic olefins). Since these components are typically present in relatively low concentrations within the bulk acid, their degradation is less likely to compromise the overall stability of the spent acid under the tested conditions.

Conversely, gas samples containing elevated levels of sulfur dioxide and water vapor are more indicative of the acid being consumed in other chemical side reactions generating polymeric species. This pattern may suggest that the acid is undergoing temperature-dependent chemical reactions, releasing volatile sulfur species such as SO₂ and moisture as byproducts. Such a profile may signal a higher risk of instability at elevated temperatures, particularly if the onset of gas evolution occurs near or below expected temperature thresholds. Analysis of the gas composition can help identify specific reaction pathways and quantify the contributions of various species to the formation of the overhead gas. This information can assist in understanding the long-term thermal stability of the spent acid, whether across a range of expected exposure temperatures or at a particular predetermined (i.e., peak) expected temperature.

The overhead gas may be sampled after a predetermined amount of time, after the heating of the sample has been completed, once a predetermined temperature has been reached, or in response to a pressure-related event, such as identification of a pressure inflection or of a sustained pressure increase. Alternatively, gas sampling may be conducted continuously or at defined intervals, with sampling frequency determined by elapsed time, specific temperature thresholds, pressure thresholds, or other experimental criteria. Periodic or event-triggered sampling allows for the construction of a temporal profile of gas evolution, which can be correlated with thermal and pressure data to better understand the progression of chemical changes within the sample.

Collecting multiple gas samples over the course of the heating of the sample enables the identification of shifts in reaction pathways as a function of time, temperature, or pressure. This approach can reveal whether gas composition remains consistent or evolves, indicating the presence of sequential or competing decomposition mechanisms. For example, early-stage gas samples may reflect the release of volatile impurities, while later samples may capture products of bulk acid thermal degradation. By analyzing these samples individually, operators can assess the onset, duration, and extent of different chemical processes, which in turn supports a more detailed evaluation of the thermal behavior and stability characteristics of the bulk chemical. Such information could also inform the volume and/or material of construction appropriate for storage and transport of the bulk chemical.

The gas volume created by heating the chemical sample can be determined by measuring the total volume collected in the syringe 280 and knowing the total volume of the gas headspace in the sample vessel 250 and of the gas transport lines 240 292 286 264. The volume produced by a chemical sample can provide insight into how much gas volume and/or pressure buildup that would be theoretically produced by a bulk sample of the same chemical. For example, a spent acid sample of a known volume and mass could be determined to produce a particular volume and mass of gas. Knowing the volume of gas produced per unit mass or unit volume of sample can be useful in determining the containment requirements when it is known that the bulk chemical will be exposed to elevated temperatures during storage or transportation.

In another step 138, the stability of the chemical sample is determined according to the pressure data and/or the gas composition. As discussed with respect to the method presented in FIG. 1A, in the present method 120, the pressure data may be evaluated for trends such as sustained increases, inflection points, or deviations from baseline behavior, which can indicate the onset of gas evolution or other thermally driven processes. These pressure features, when correlated with temperature, can help identify thresholds at which the sample begins to undergo chemical change and produce gaseous species.

In parallel, the composition of the evolved overhead gas provides complementary information about the nature of those changes. For instance, the presence and relative abundance of specific gaseous species-such as sulfur dioxide, water vapor, or hydrocarbons/hydrocarbon complexes—can suggest whether the observed pressure increase is due to degradation of the bulk acid material or the release of minor constituents or contaminants. By integrating both pressure and compositional data, a more complete picture of the chemical sample's thermal behavior can be developed. This combined analysis allows for the identification of temperature ranges where the sample remains thermally stable, as well as regions where chemical transformations are likely occurring.

In some cases, the combined pressure and gas composition data may also be used to compare the thermal behavior of different samples or formulations under similar test conditions. This comparative approach can help identify patterns or consistencies across samples with shared characteristics, such as acid strength, impurity profile, or processing history. By referencing results from previously tested samples, it may be possible to infer the expected stability of a new sample without requiring a full-length thermal analysis. For example, if multiple spent acid samples of a particular strength have demonstrated consistent stability profiles, a new sample of similar composition may be assessed more quickly by focusing on key temperature, pressure, or gas composition markers identified in earlier tests.

This strategy can reduce the time and resources required for testing by narrowing the scope of analysis to the most relevant conditions. It also supports the development of reference datasets or stability benchmarks, which can be used to screen new materials or monitor process consistency over time. In some implementations, statistical or machine learning models (AI models) may be applied to historical data to predict the behavior of untested samples based on their known properties, further enhancing the efficiency of the evaluation process. In some cases, this information may also be used to compare the behavior of similar samples or formulations under similar thermal conditions, thereby allowing testing to be performed in less time. For example, the stability of acids at a particular strength may be quickly assessed based on the results of previous tests for spent acid samples of similar strength.

In the present methods 100 120, the chemical sample may be heated more rapidly than in standard ARC tests. As a non-limiting example, the chemical sample may be heated at a rate of about 2 K/min. With an upper temperature limit of about 55° C., this results in a method that can be performed in about 1-3 hours. By comparison, previously known methods for testing the thermal stability of a chemical sample may take up to 2 days. Further, the present methods use a small mass or volume of sample to carry out the methods. As a non-limiting example, the chemical sample tested is from about 1 mL to about 10 mL, or from about 2 mL to about 3 mL. As another non-limiting example, the chemical sample tested is from about 1 g to about 5 g, or from about 3 g to about 4 g.

### Methods of Operating an Alkylation Reactor

In another aspect, the present methods may further comprise adjusting feed to an alkylation reactor based on the results of thermal stability testing of the chemical samples. As the acid can be tested in 1-3 hours or less, testing can be frequent, allowing for relatively frequent adjustment to alkylation feed compositions in order to maximize acid effectiveness. Frequent adjustments to the alkylation feed may also bring positive economic results, as stronger acids may be used to create more valuable products using olefins, such as propylene, butylene and amylene, as a reactant.

In some embodiments, the method further comprises adjusting a feed composition to an alkylation reactor based on the determined stability of the chemical sample. In some embodiments, the feed composition is adjusted to increase an amount of olefin in the feed composition when the chemical sample is determined to be stable at the predetermined threshold temperature. In some embodiments, the feed composition is adjusted to decrease the amount of isobutane mixed into the feed composition when the chemical sample is determined to be stable at the predetermined threshold temperature. In some embodiments, the method further comprises adjusting energy applied to a mixing apparatus within an alkylation reactor based on the determined stability of the chemical sample. In some embodiments, the mixing intensity is increased when the chemical sample is determined to be unstable at the predetermined threshold temperature.

In some embodiments, the method is performed using an accelerating rate calorimeter.

In some embodiments, the chemical sample is determined to be stable at the predetermined threshold temperature if the sample temperature at the pressure inflection point exceeds the predetermined threshold temperature or if there is no inflection point observed within the pressure data; and wherein the chemical sample is determined to be unstable at the predetermined threshold temperature if the predetermined threshold temperature exceeds the identified sample temperature at the pressure inflection point.

Turning to FIG. 1C, provided herein is a method 140 of operating an alkylation reactor, the method including steps carried out according to the methods disclosed above. The method includes carrying out a stability of an acid sample from the reactor according to the methods 100 120 described above, and then changing an operating parameter of the reactor according to the results of the stability analysis. In some embodiments, the method includes obtaining an acid solution sample from a spent acid solution; heating the acid solution sample within a calorimetric device, wherein the heating is controlled by a computer-implemented program applying heat to the calorimetric device according to a rate defined in at least a portion of a predetermined heating process; measuring a pressure within the calorimetric device while heating the acid solution sample; measuring a temperature of the acid solution sample while applying heat according to the computer-implemented program; identifying a pressure inflection point in the pressure data recorded during the heating program wherein after the pressure inflection point is associated with a sustained pressure increase; identifying the temperature or temperature range at the identified pressure inflection point; optionally sampling an overhead gas from the calorimetric device and determining the composition thereof; and determining stability of the acid solution sample at a predetermined temperature by comparing the identified sample temperature and the predetermined threshold temperature; and adjusting a feed composition to the alkylation reactor according to the determined stability of the acid solution sample.

In a step 150, a sample of the acid catalyst in the alkylation reactor is obtained. This acid sample may be a spent acid reaching the end of its useful life. The acid may also be a strong acid, in which case it may be tested to determine if the concentration of olefin, such as propylene, butylene, and amylene, in the alkylation reactor feed may be increased while still maintaining the desired efficiency of the alkylation process.

In another step 152, the sample is heated in a calorimetric device and the pressure of the sample is measured. This step is performed according to the steps 110 112 of the method discussed above, and the discussion regarding these steps applies to the present discussion. The heating may include a constant heating rate, a stepwise heating rate having a single step, a stepwise heating rate more than one step, a time-variable heating rate, a temperature-variable heating rate, a pressure-variable heating rate, or a combination of any two or more thereof. The heating rate may be controlled by a computer, as described in more detail below, or may be manually adjusted. The pressure is measured by a pressure transducer or similar instrument.

In another step 154, a pressure inflection point or range is identified in the pressure data, indicative of the acid sample beginning to thermally decompose. The pressure inflection point may be associated with a sustained pressure increase. In some embodiments, the step 154 includes: processing the pressure data to identify a portion of the pressure data associated with a time interval in which the pressure data includes at least one of: a pressure value that is greater than a target pressure value; a slope of pressure value that is greater than a target slope value; a rate of change in the pressure value that is greater than a target rate of change value; an acceleration in the rate of change of the pressure value that is greater than a target acceleration value; and a monotonic increase in pressure; and identifying a local minimum pressure value contained within or before the associated time interval. In some embodiments, the pressure data and the sample temperature data are monitored in real-time. Other discussion above with respect to determining or identifying a pressure inflection also applies to the present method of operating an alkylation reactor 140.

In optional steps 160 162, a sample of overhead gas in the calorimetric device is obtained and the gas sample is tested to determine the composition. As discussed in reference to the method of determining the stability of a chemical sample 120, the sample may be obtained via a gas sample port and is analyzed using any known or unknown technique, such as though not limited to GC, MS, GC-MS, GC-MS, FTIR, VUV, RAMAN, IGA, laser absorption spectroscopy, or others. These techniques enable both qualitative and quantitative characterization of the gaseous species present in the sample. When used in tandem, GC-MS offers high-resolution analysis capable of detecting trace-level species, reaction intermediates, and decomposition products with high specificity.

Quantification of gas-phase components may be achieved through calibration with external standards, and the use of internal standards can improve measurement accuracy and reproducibility. The selection of target analytes for analysis is typically informed by the chemical nature of the sample and the expected thermal decomposition pathways. Common species of interest may include carbon dioxide (CO₂) and a variety of light hydrocarbons and organic volatiles, along with species related to the matrix of the acid (i.e., sulfur species for sulfuric acid samples).

For spent acid samples, which may contain contaminants such as acid-soluble oils (ASO) and, in some cases, amines, the analytical focus may expand to include lighter hydrocarbons, amino-hydrocarbon complexes, oxygenated acid-base derivatives, and other species formed through acid-base interactions. For example, when analyzing spent sulfuric acid, relevant species may include sulfur dioxide (SO₂), water (H₂O), organic hydrocarbons, organic sulfates, sulfur complexes, and organic fragments such as amino-methyl, ethyl, and propyl structures. Light (C1-C5) hydrocarbons, such as ethane, ethene, propane, propene, iso-butane, n-butane, iso-butene, butene, pentane, iso-pentane, pentene, and iso-pentene, may also be present. Depending on the origin and composition of the sample, additional species such as olefins or partially oxidized organics may be detected, offering further insight into the chemical history and thermal behavior of the acid. Other discussion regarding step 136 applies to steps 160 and 162 of the present method 140 as well.

In another step 156, the stability of the acid sample is assessed based on the pressure data and, optionally, the composition of the overhead gas. As described in step 138, the pressure data may be analyzed for features such as sustained increases, inflection points, or deviations from baseline behavior. These features can indicate the onset of gas evolution or other thermally induced changes within the spent acid sample. When evaluated in conjunction with temperature data, these pressure trends help identify specific thresholds at which the sample begins to undergo chemical transformation, potentially leading to the formation of gaseous byproducts.

Additionally, the composition of the evolved overhead gas may offer additional insight into the nature of these transformations. The presence and relative concentrations of specific gaseous species—such as sulfur dioxide, water vapor, or hydrocarbons and hydrocarbon complexes—can help distinguish between decomposition of the bulk acid and the release of minor constituents or residual contaminants. For example, a predominance of sulfur-containing gases may suggest direct acid degradation, while hydrocarbon-rich profiles may point to the breakdown of organic impurities. By integrating both pressure and compositional data, a more comprehensive understanding of the sample's thermal behavior can be achieved. This combined analysis supports the identification of temperature ranges where the sample remains stable, as well as regions where chemical changes are more likely to occur, enabling more informed evaluation of the acid sample's performance under thermal stress.

In another step 158, an operating parameter of the alkylation reactor is adjusted based on the results of the stability test of the acid sample. In some embodiments, the feed composition to the alkylation reactor is adjusted. Adjusting the feed composition to the alkylation reactor may include increasing a concentration of olefin, such as propylene, butylene, and/or amylene in the feed composition if the identified sample temperature at the pressure inflection point exceeds the predetermined threshold temperature (i.e., the acid demonstrates stability at the predetermined temperature or range). In cases where the acid is stable at the predetermined temperature or temperature range, the amount of amylene or butylene provided to the alkylation reactor may be increased. In some embodiments, adjusting the feed composition to the alkylation reactor includes decreasing isobutane content of the feed if the identified sample temperature at the pressure inflection point exceeds the predetermined threshold temperature (i.e., the acid demonstrates instability at the predetermined temperature or range).

In additional embodiments, other operating parameters may be modified in response to the acid stability data, such as reactor target operating temperature, acid circulation rate, fresh acid addition rate, or acid-to-hydrocarbon ratio. For example, if the acid demonstrates reduced stability at a given operating temperature, the reactor temperature may be lowered to maintain acid performance within a more stable range. Similarly, the acid circulation rate may be increased to reduce residence time and limit thermal exposure of the acid. These adjustments can help maintain consistent alkylation performance while optimizing acid utilization. Over time, trends in acid stability data may also inform broader process strategies, such as refining acid regeneration schedules or selecting feedstocks that are better matched to the thermal characteristics of the acid in use.

### Control System

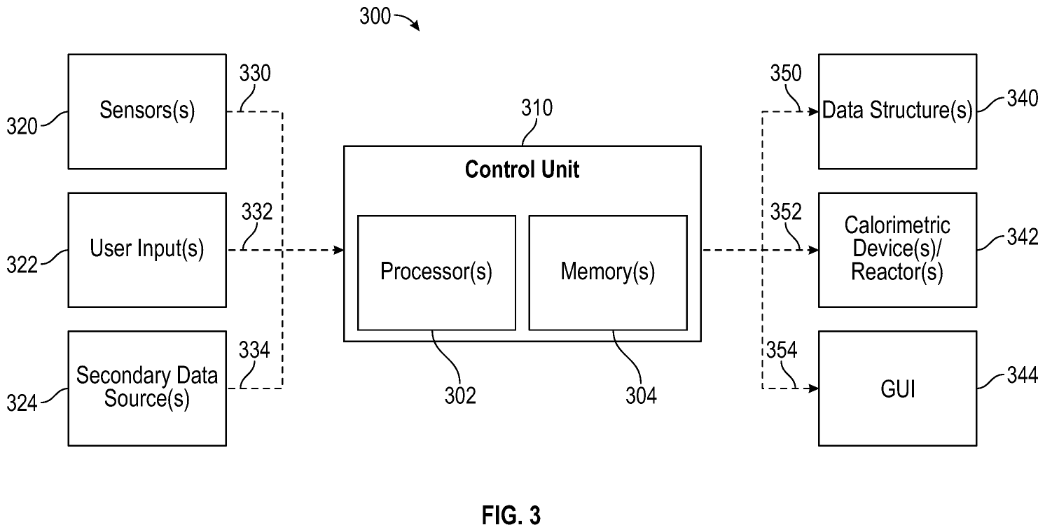

The heating of the sample 252 and other steps of the methods disclosed herein may be controlled by a computer. An example schematic of a control circuit 300 is illustrated in FIG. 3, which may be used to control functions of the calorimetric device. In an embodiment, the control circuit 300 includes a control unit 310, which includes one or more processors 302 and a computer memory 304. The control unit 310 may be a combination of, but not limited to, a set of instructions stored on a computer memory 304, one or more processors 302 configured to execute the set of instructions, a Random Access Memory (RAM), a Read Only Memory (ROM), flash memory, a data structure, and the like. The memory 304 stores code or executable instructions that, when executed by the one or more processors 302, sends signals 352 that control the operation of the calorimetric device 342. The signals 352 may direct a controller on the calorimetric device 342 itself to operate the heating elements or to open or close a seal or valve, or other functions. The control unit 310 may cause the calorimetric device 342 to heat a sample contained within the device at a predetermined rate. The heating rate may be constant, stepwise, or variable with time, temperature, pressure, or according to another variable or measurement.

With continued reference to FIG. 3, the control unit 310 may be configured to measure, using the one or more processors 302 and memory 304, a temperature and/or pressure associated with the calorimetric device. Such data 330 may be received from one or more sensors 320. The control unit 310 may also be configure to receive information, inputs, data, signals 332 from an operator via a user input device 322, such as a keyboard, mouse, or touchscreen. The control unit 310 may also be configure to receive information, inputs, data, signals 334 from or more secondary data sources. Examples of secondary data sources 324 include, but are not limited to, data not stored in the control unit memory 304, queryable databases, networks, internet sites, online resources, artificial intelligence (AI) agents, etc.

In addition to sending signals 352 to the calorimetric device 342, the control unit 310 may be configured to provide an output to a user interface 344, such as a graphical user interface (GUI). This may include displaying data or other information on a screen for an operator or illuminating a light, for example, though not limited to such. Any user interface may be used to present information to the user. The control unit 310 may be configured to provide an output to one or more data structures 340, which may include saving data 350 to a memory, external or secondary data repository, sending data over a network, etc.

The control unit 310 may be configured to perform one or more steps of the methods described herein. The control unit 310 may control the heating of the calorimetric device 342. The control unit 310 may measure the pressure and temperature of the chemical samples and record that data for an operator. The control unit 310 determine a stability temperature of a chemical sample according to pressure data, such as by determining a pressure inflection point. The control unit 310 determine a stability temperature of a chemical sample according to pressure data and an overhead gas composition. The control unit may determine the stability temperature by one or more mathematical operations and/or other functions performed on one or more data sets. The control unit 310 may be configured to apply artificial intelligence (AI) models to the data to determine the stability of the chemical sample and/or to calculate the gas volume or expected pressure increase for a given chemical sample volume. For example, the control unit 310 may apply an artificial neural network, deep learning model, probabilistic model, or other known or unknown AI models to make the determinations or to assist an operator to make the determinations.

In some embodiments, the control circuit 300 includes a control unit 310 configured to control at least some of the operation of a reactor 342 associated with the chemical sample. For example, in some embodiments, the control unit 310 is configured to send signals 352 that cause the position of one or more valves associated with the reactor to adjust their position, thereby changing the federate of a feed stream to the reactor 342. The control unit 310 may be the same control unit that controls the calorimetric device, or may be a different device.

### EXAMPLES

The present invention, thus generally described, will be understood more readily by reference to the following examples, which are provided by way of illustration and are not intended to be limiting of the present invention.

### Example 1

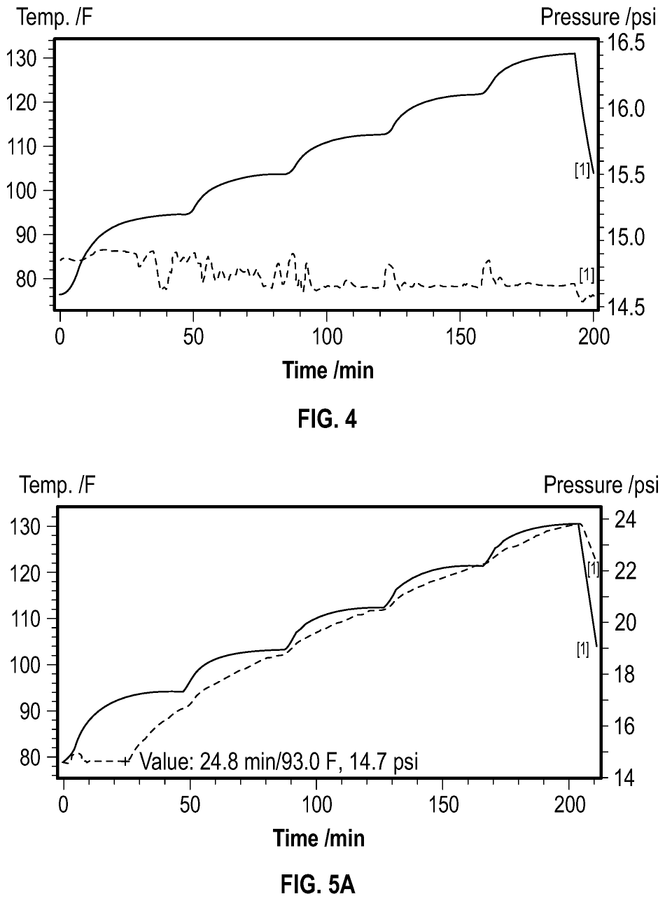

In a sealed calorimeter, a chemical sample containing a stable spent acid (acid strength 90.4 wt. %) was heated to 130° F. using a stepwise heating program. The sample was obtained from an operating alkylation reactor. The temperature of the sample and the pressure of the pressure vessel was measured as the sample was heated at a specified heating regimen. The sample was first heated to about 95° F. over 50 minutes, and then additional heat was applied to raise the sample temperature by an additional 9° F. each 40 minutes. The heating was controlled by a computer. There was no significant rise in pressure observed (FIG. 4). It was thus determined that the acid sample was stable over the tested temperature range of 75° F. to 130° F.

### Example 2

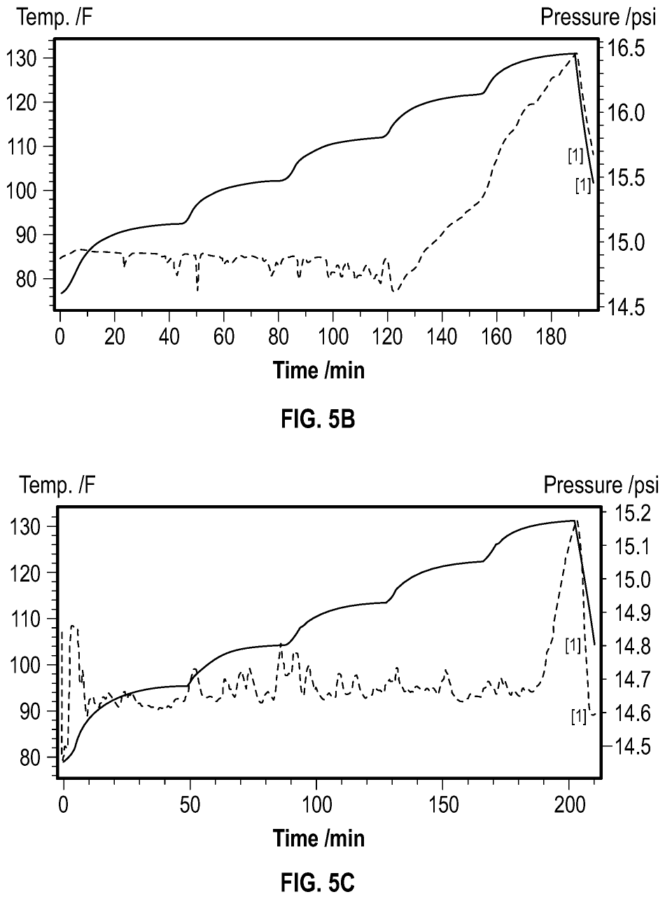

In a sealed calorimeter, a chemical sample containing an unstable spent acid (acid strength 86.9 wt. %) was heated to 130° F. using a stepwise heating program as described in Example 1. Again, the chemical sample was obtained from a functioning alkylation reactor. A sustained linear rise in pressure was observed starting when the sample temperature was around 93° F. (FIG. 5A). The pressure rise was determined to be sustained, unlike the pressure rise observed at a sample temperature of about 83° F. In FIG. 5A, the pressure inflection point leading the sustained pressure increase is labeled. It was determined that the sustained pressure increase observed was due to a runaway exothermic reaction of the acid can be seen starting at about 25 minutes into the test, corresponding to a temperature of about 93° F. It was determined that the spent acid sample was stable at temperatures below 93° F.

### Example 3

In a sealed calorimeter, a chemical sample containing an unstable spent acid (acid strength 89.5 wt. %) was heated to 130° F. using a stepwise heating program as described in Example 1. The chemical sample was obtained from a functioning alkylation reactor. A sustained linear rise in pressure was observed starting when the sample was heated to around 116° F. (FIG. 5B). Without wishing to be bound by theory, it is believed that the sustained rise in pressure was related to self-heating of the acid due to continued decomposition of the acid beginning at about 116° F. It was determined that the spent acid sample was stable at temperatures below 116° F.

### Example 4

In a sealed calorimeter, a chemical sample containing an unstable spent acid (acid strength 90.2 wt. %) was heated to 130° F. using a stepwise heating program as described in Example 1. The chemical sample was obtained from a functioning alkylation reactor. A sustained linear rise in pressure was observed starting around 130° F. (FIG. 5C). Under 130° F., many pressure perturbations were observed, but none resulting in a sustained pressure increase. Without wishing to be bound by theory, it is believed that the perturbations may have been the result of contaminants such as ASO reacting with each other or with the acid in the sample. The sustained rise in pressure is related to self-heating of the acid due to continued decomposition of the acid beginning at a sample temperature of about 130° F. It was determined that the spent acid sample was stable at temperatures below 130° F.

### Example 5

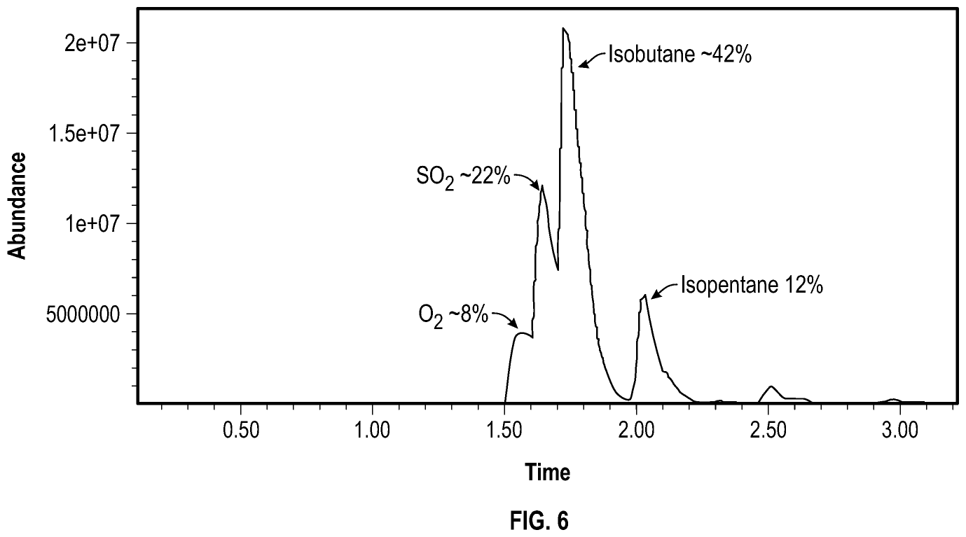

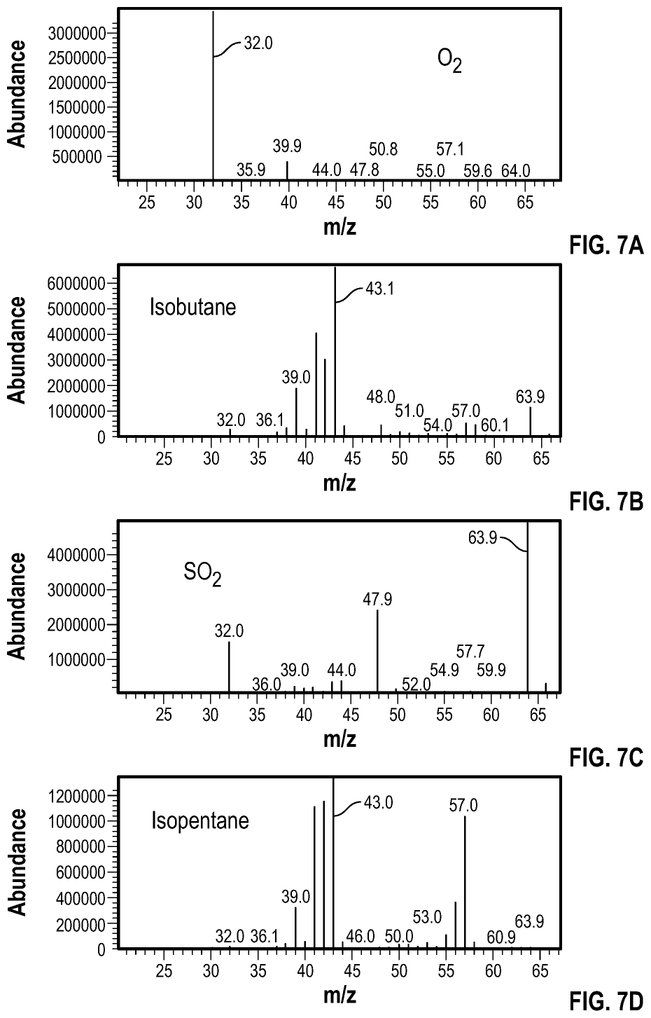

In a sealed calorimeter, a chemical sample containing an unstable spent acid was heated until a runaway reaction was observed via pressure data. A sample of the overhead gas in the sealed calorimeter was obtained via a syringe. The overhead gas sample was analyzed via GC-MS, with the results displayed as a total ion chromatogram (TIC). The TIC chromatogram results are provided in FIGS. 6 and 7. The TIC data shows primary peaks in the front end (e.g., the first 2.5 minutes of the chromatogram) corresponding to the major head space components. In FIG. 6, peaks corresponding to oxygen, sulfur dioxide, isobutane, and isopentane were identified as making up the majority of the gas species. Further TIC spectra, as shown in FIGS. 7A-D confirms the presence of oxygen, sulfur dioxide, isobutane, and isopentane as main species in headspace gas sample.

### Definitions

While the methods herein are described in terms of “steps,” it should be understood that the steps are not indicated to be performed in a strict order. Further, the steps may be performed, at least in part, concurrently. For example, heating the sample may be performed concurrently as measuring the pressure, determining pressure inflection points and associated temperatures, taking gas samples, etc.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, comparative terms as used herein, such as higher, lower, increase, decrease, reduce, or any grammatical variation thereof, can refer to certain variation from the reference. In some embodiments, such variation can refer to about 10%, or about 20%, or about 30%, or about 40%, or about 50%, or about 60%, or about 70%, or about 80%, or about 90%, than the reference. In some embodiments, such variation can refer to about 1%, or about 2%, or about 3%, or about 4%, or about 5%, or about 6%, or about 7%, or about 8%, or 9%, or about 10%, or about 20%, or 30%, or 40%, or 50%, or 60%, or 70%, or 75%, or 80%, or 85%, or 90%, or about 95%, or about 96%, or about 97%, or about 98%, or about 99% of the reference.

“Optional” or “optionally” means that the subsequently described circumstance may or may not occur, so that the description includes instances where the circumstance occurs and instances where it does not.

As used herein, “and/or” refers to and encompasses any and all possible combinations of one or more of the associated listed items, as well as the lack of combinations when interpreted in the alternative (“or”).

Various embodiments are described herein. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can of course vary. It is also to be understood that the terminology used herein is for the purpose of describing particular embodiments only, and is not intended to be limiting.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An analytic method for determining stability of a chemical sample, the method comprising:
heating the chemical sample within a calorimetric device, wherein the heating is controlled by a computer-implemented program applying heat to the calorimetric device according to a rate defined in at least a portion of a predetermined heating process;
measuring, by a pressure transducer, a pressure associated with the calorimetric device while applying heat to the chemical sample according to the computer-implemented program;
measuring, by a temperature sensor, a temperature of the chemical sample while applying heat to the chemical sample according to the computer-implemented program;
determining a pressure inflection point in the pressure data recorded during the heating program, wherein after the pressure inflection point is a sustained pressure increase;
determining the chemical sample temperature corresponding with the identified pressure inflection point;
determining stability of the chemical sample at the pressure inflection point by comparing the identified temperature and a predetermined threshold temperature.

2. The method of claim 1, wherein the chemical sample is obtained from an acid solution comprising one or more acids diluted with one or more solvents, the acid solution having an acid strength of about 70 w/w % to about 100 w/w %.

3. The method of claim 1, wherein the predetermined heating process comprises a constant heating rate, a stepwise heating rate including a single step, a stepwise heating rate including multiple steps, a time-variable heating rate, a temperature-variable heating rate, a pressure-variable heating rate, or a combination of any two or more thereof.

4. The method of claim 1, wherein determining the pressure inflection point includes:
trending output data from the pressure transducer to identify a time interval after a sustained pressure increase occurs, wherein the output data includes at least one of:
a pressure value that is greater than a target pressure value;
a slope of pressure value that is greater than a target slope value;
a rate of change in the pressure value that is greater than a target rate of change value;
an acceleration in the rate of change of the pressure value that is greater than a target acceleration value; and
a monotonic increase in pressure; and
identifying a local minimum pressure value contained within or before the associated time interval.

5. The method of claim 1, wherein the chemical sample is determined to be stable at the predetermined threshold temperature if the sample temperature at the pressure inflection point exceeds the predetermined threshold temperature or if there is no inflection point observed within the pressure data; and wherein the chemical sample is determined to be unstable at the predetermined threshold temperature if the predetermined threshold temperature exceeds the identified sample temperature at the pressure inflection point.

6. The method of claim 5 further comprising adjusting a feed composition to an alkylation reactor based on the determined stability of the chemical sample.

7. The method of claim 6, wherein the feed composition is adjusted to increase an amount of olefin in the feed composition when the chemical sample is determined to be stable at the predetermined threshold temperature; or wherein the feed composition is adjusted to decrease the amount of isobutane mixed into the feed composition when the chemical sample is determined to be stable at the predetermined threshold temperature.

8. The method of claim 5 further comprising adjusting energy applied to a mixing apparatus within an alkylation reactor based on the determined stability of the chemical sample.

9. The method of claim 8, wherein mixing intensity is increased when the chemical sample is determined to be unstable at the predetermined threshold temperature.

10. An analytic method comprising:
heating a chemical sample within a pressure chamber, wherein the heating is according to at least a portion of a predetermined heating process;
measuring a pressure within the pressure vessel while heating the chemical sample to produce pressure data;
measuring a temperature of the chemical sample while heating the chemical sample to produce sample temperature data;
identifying in the pressure data a pressure inflection point associated with a sustained pressure increase; and
processing the sample temperature data to determine a stability temperature of the chemical sample, wherein the stability temperature is the temperature of the chemical sample associated with a minimum pressure of the identified sustained pressure increase.

11. The method of claim 10, wherein the chemical sample is obtained from an acid solution comprising one or more acids diluted with one or more solvents, the acid solution having an acid strength of about 70 w/w % to about 100 w/w %.

12. The method of claim 10, wherein the predetermined heating process comprises a constant heating rate, a stepwise heating rate, a time-variable heating rate, a temperature-variable heating rate, a pressure-variable heating rate, or a combination of any two or more thereof.

13. The method of claim 10 further comprising adjusting a feed composition to an alkylation reactor based on the determined stability temperature of the chemical sample.

14. The method of claim 13, wherein the feed composition is adjusted to increase an amount of olefin in the feed composition when the stability temperature of the chemical sample is greater than a predetermined threshold temperature.

15. A method of operating an alkylation reactor, the method comprising:
obtaining an acid solution sample from an acid solution;
heating the acid solution sample within a calorimetric device, wherein the heating is controlled by a computer-implemented program applying heat to the calorimetric device according to a rate defined in at least a portion of a predetermined heating process;
measuring a pressure within the calorimetric device while heating the acid solution sample;
measuring a temperature of the acid solution sample while applying heat according to the computer-implemented program;
identifying a pressure inflection point in the pressure data recorded during the heating program wherein after the pressure inflection point is a sustained pressure increase;
identifying the temperature at the identified pressure inflection point;
determining stability of the acid solution sample at a predetermined temperature according to the identified pressure inflection temperature and the predetermined threshold temperature; and
adjusting a feed composition to the alkylation reactor according to the determined stability of the acid solution sample.

16. The method of claim 15, wherein adjusting the feed composition to the alkylation reactor includes increasing a concentration of olefin in the feed composition if the identified sample temperature at the pressure inflection point exceeds the predetermined threshold temperature; or wherein adjusting the feed composition to the alkylation reactor includes decreasing isobutane content of the feed if the identified sample temperature at the pressure inflection point exceeds the predetermined threshold temperature.

17. The method of claim 15, wherein the predetermined heating process includes a constant heating rate, a stepwise heating rate having a single step, a stepwise heating rate more than one step, a time-variable heating rate, a temperature-variable heating rate, a pressure-variable heating rate, or a combination of any two or more thereof.

18. The method of claim 15, wherein identifying a pressure inflection point associated with a sustained pressure increase in the pressure data includes:
processing the pressure data to identify a portion of the pressure data associated with a time interval in which the pressure data includes at least one of:
a pressure value that is greater than a target pressure value;
a slope of pressure value that is greater than a target slope value;
a rate of change in the pressure value that is greater than a target rate of change value;
an acceleration in the rate of change of the pressure value that is greater than a target acceleration value; and
a monotonic increase in pressure; and
identifying a local minimum pressure value contained within or before the associated time interval.

19. The method of claim 15, further comprising obtaining a sample of an overhead gas produced during heating of the acid solution sample; and
analyzing the overhead gas sample to determine a composition of the overhead gas sample,
wherein the overhead gas sample composition is determined by one or more of GC-MS, MS, and FTIR.

20. The method of claim 19, wherein determining the stability of the acid solution sample at the predetermined temperature is performed according to the identified pressure inflection temperature, the overhead gas composition, and the predetermined threshold temperature.
